(19) United States
(12) Patent Application Publication
(10) Pub. No.: US 2018/0011044 A1
(43) Pub. Date: Jan. 11, 2018

(54) NON-DESTRUCTIVE WEAR MONITORING SYSTEM FOR SYNTHETIC ROPES AND TEXTILES

(71) Applicant: Physical Optics Corporation, Torrance, CA (US)

(72) Inventors: Sivanesan Ponniah, Cerritos, CA (US); Alexander Kolessov, Torrance, CA (US); Nikolas Aizpuru, Lakewood, CA (US); Brandon Janca, Huntington Beach, CA (US)

(73) Assignee: Physical Optics Corporation, Torrance, CA (US)

(21) Appl. No.: 15/485,170

(22) Filed: Apr. 11, 2017

Related U.S. Application Data
(60) Provisional application No. 62/360,870, filed on Jul. 11, 2016.

(51) Int. Cl. G01N 27/20; G01N 27/04

(52) U.S. Cl. CPC G01N 27/20; G01N 27/041

(57) ABSTRACT

Embodiments disclosed herein include system and methods for monitoring synthetic ropes for damage. One embodiment may include a synthetic rope with non-conductive fibers and conductive fibers. The conductive fibers may include a conductive core and a non-conductive sheath surrounding the conductive core. The conductive fibers may be grouped and terminated to form an electrical termination point. Additionally, an electronic reader may be configured to make contact with the electrical termination point to measure the electrical resistance of the synthetic rope.

### CROSS RELATED APPLICATIONS

This application claims priority to provisional application 62/360,870 filed on Jul. 11, 2016.

### TECHNICAL FIELD

The disclosed technology relates generally to synthetic fiber ropes and textiles. More specifically, the disclosed technology relates to monitoring and assessing the damage of synthetic fiber ropes and textiles.

### BACKGROUND

Synthetic ropes and textiles are made from fibers of both natural and synthetic fibers. For example, a plurality of fiber strands may be combined and then twisted to create yarn strands, which may then be combined to from synthetic fiber ropes.

The reliability and strength of synthetic rope or similar textile are critically dependent upon the amount fibers that remain non-fractured within the layers of the rope. Indeed, with use and time, the fibers in the rope eventually breakdown from normal wear and tear. Additionally, the rope may further become damaged when foreign particles induce friction and abrasion within the yarn and fibers of the rope.

The conventional method of determining whether the condition of the rope or textile is safe for continuous use is often through visual inspection. However, especially for multi-layer braided ropes, visual inspection can only be performed for the outer layer braids. Thus, visual inspection is seriously lacking and even misleading because one cannot assess the damages of the inner layer or ropes, which generally handles the majority of the load-bearing capacity for the ropes.

While another common method for inspecting the condition of a rope is done by destructive testing to determine the accurate residual strength of the rope, this causes irreparable damage to the rope. As a result, there is currently a need for a new system and method for accurately testing and determining the strength of the synthetic rope without degrading the structure or integrity of the rope.

### BRIEF SUMMARY OF EMBODIMENTS

According to various embodiments of the disclosed technology, disclosed is a system for monitoring synthetic ropes for damage. In one embodiment, the system may include a synthetic rope with non-conductive fibers and conductive fibers. The conductive fibers may include a conductive core and a non-conductive sheath surrounding the conductive core. The conductive fibers may be grouped and terminated to form an electrical termination point. Additionally, an electronic reader may be configured to make contact with the electrical termination point to measure the electrical resistance of the synthetic rope.

Additionally, one embodiment of the method for monitoring synthetic ropes for damage may include obtaining a synthetic rope comprising non-conductive fibers and conductive fibers. The conductive fibers may include a conductive core and a non-conductive sheath surrounding the conductive core, where the conductive fibers are grouped and terminated to form an electrical termination point. The method may further include placing an electronic reader in contact with the electrical termination point to measure an electrical resistance of the synthetic rope.

Other features and aspects of the invention will become apparent from the following detailed description, taken in conjunction with the accompanying drawings, which illustrate, by way of example, the features in accordance with embodiments of the invention. As such, the summary is not intended to limit the scope of the invention.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a multi-layer synthetic rope with conducting fibers and non-conducting fibers according to one embodiment of the present invention.

FIG. 2 illustrates a single conducting fiber according to one embodiment of the present invention.

FIG. 3 illustrates a bundle of conductive fibers to create conductive yarn according to one embodiment of the present invention.

FIG. 4 illustrates a cross-section of a synthetic rope bundle containing both conductive yarn and non-conductive yarn according to one embodiment of the present invention.

FIG. 5 illustrates a multi-layer synthetic rope with a protective wrap at one end according to one embodiment of the present invention.

FIG. 6 illustrates a protective attachment end with electrical connections according to one embodiment of the present invention.

FIG. 7 illustrates an electronic device configured to connect directly onto the electrical terminations on a rope according to one embodiment of the present invention.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

The disclosed embodiments disclose a system and method for monitoring and determining the strength of ropes or textiles. By way of example only, a rope may include conductive fibers or threads that are braided or weaved with non-conductive fibers or threads to create a synthetic rope. Because the loss in strength or damage to a rope may be directly related to the number broken fiber in each strand of the rope, monitoring the number of the damaged fibers may be done by obtaining electrical resistance measurements of the conductive fibers in the rope. In other words, the bulk electrical resistivity of the yarn may be directly proportional to the number of undamaged fibers in the yarn of the rope. An electronic reader may be used take the electrical resistance measurements, such that the a when the electrical resistance of the rope is past a predefined break strength limit, the rope may be characterized as unsafe for continuous or prolonged use.

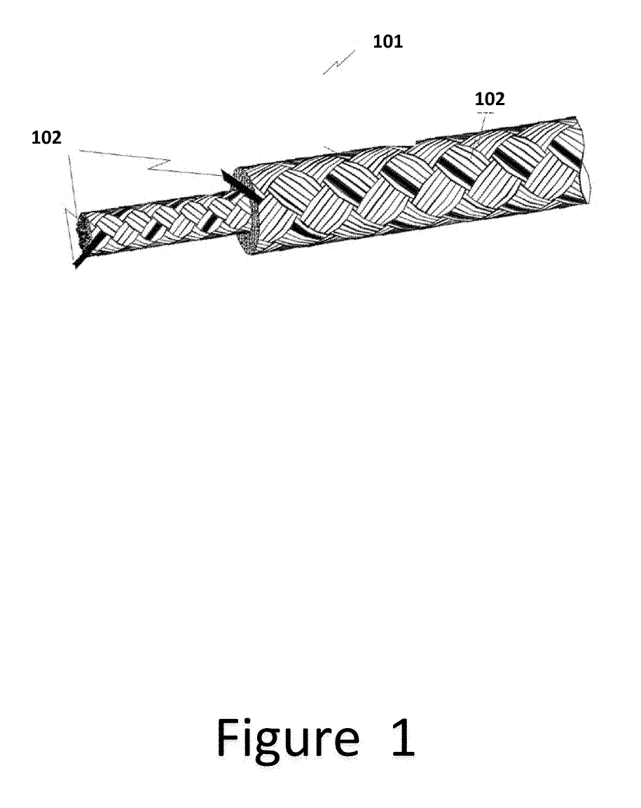

FIG. 1 illustrates a multi-layer synthetic rope 101 with conducting fibers 102 and neat, or non-conducting, fibers 103 according to one embodiment of the present invention. As illustrated, the multi-layer synthetic rope 101 may have two layers, an inner layer and an outer layer. However, it should be noted that in some embodiments, a single layer may be used while in other instances, three or more layers may be present in the multi-layer synthetic rope 101.

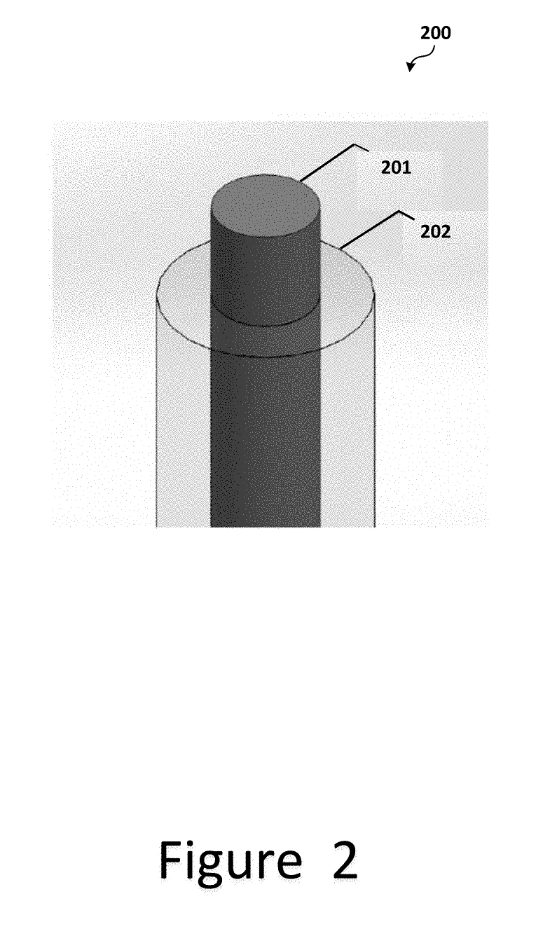

FIG. 2 illustrates a single conducting fiber 200 according to one embodiment of the present invention. As illustrated, the conducting fiber 200 may include a conductive core 201. By way of example only, the conductive core 201 may include conductive nanomaterial, such as carbon black, carbon nanotube, graphene and the like.

As further illustrated, the conductive core 201 may also include a sheath layer 202. By way of example only, the sheath layer 202 may be constructed of neat nylon to insulate the conductive core 201 and ensure electrical resistance monitoring along the entire length of the fiber or rope. Other additional examples of the material to be used from the sheath layer may include any other non-conductive material. Additionally, the sheath layer 202 may further help minimize any electrical cross circuiting.

By way of further example only, the conducting fiber 200 may have an overall diameter of 50 μm and the conductive core 201 may have a diameter of 25 μm. However it should be noted that the conductive fiber and the conductive core may have any overall diameter as would be used or appreciated in the industry. The provided examples are not to be limiting in any sense.

To fabricate a single conductive yarn, a number of conductive fibers 201 may be spun or grouped together to create a conducting textile yarn. Table 1 below compares the targeted mechanical and electrical properties of conductive and non-conductive textile yarns.

TABLE 1
Target Mechanical and Electrical Properties of
Conductive and Non-Conductive Textile Yarns

| | Number | | | Ultimate | Resistance |
|---|---|---|---|---|---|
| | of | | Break | Tensile | per Unit |
| | Fibers | Denier | Strain (%) | Load (N) | Length (Ω/m) |
| Conductive | 144 | 1300 | 125 | 20 | 1025 |
| Textile Yarn | | | | | |
| Non- | 144 | 1300 | 60 | 90 | — |
| conductive | | | | | |
| Textile Yarn | | | | | |

As described, Table 1 indicates that a synthetic rope may be constructed from conductive yarn and non-conductive yarn. More specifically, a single conductive yarn may be fabricated from grouping and twisting 144 individual conductive fibers 201 together and a single non-conductive yarn may be fabricated from grouping and twisting 144 individual non-conductive fibers together. The conductive yarn and non-conductive yarn may then be woven together to from a rope.

The table further includes mechanical and electrical properties of an exemplary conductive yarn and non-conductive yarn, such as the break strain percentage, tensile load, and resistance per unit length. Based on the mechanical and electrical properties of the conductive yarn and non-conductive yarn, the rope's break strength limit may be determined, which will indicate when the rope is considered to be no longer safe for use.

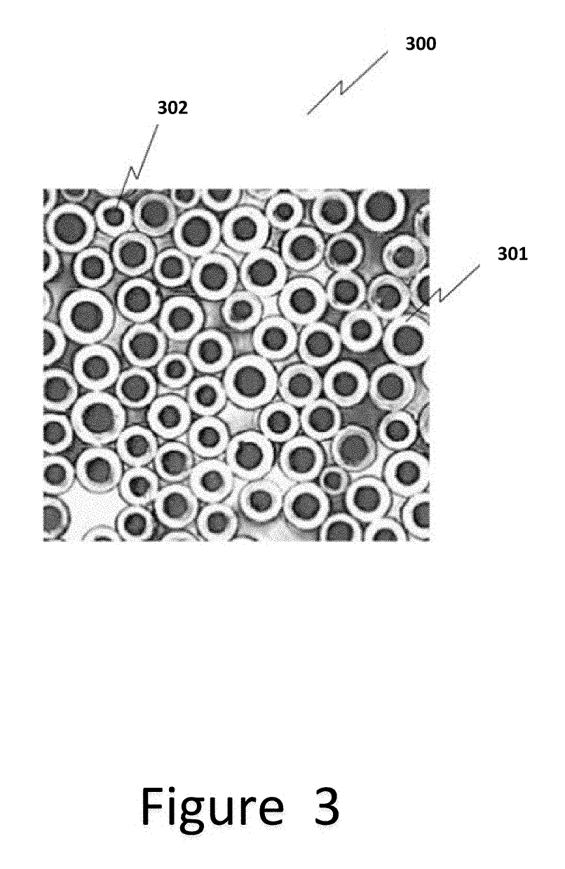

FIG. 3 illustrates a bundle of conductive fibers 300 to create conductive yarn according to one embodiment of the present invention. As illustrated, the bundle of conductive fibers 300 may each include a number of single conductive fiber with a conductive core 302 and a non-conductive outer layer 301 surrounding the conductive core 302.

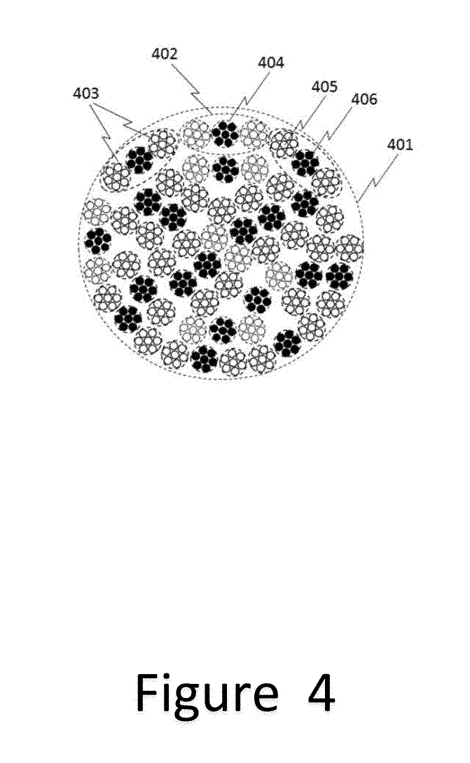

In some embodiments, the conductive yarn created from a bundle of conductive fibers 300 may be woven or intertwined with non-conductive yarn, where the non-conductive yarn may be created from a bundle of non-conductive fibers, as depicted in in FIG. 4

FIG. 4 illustrates a cross-section of a rope bundle 401 containing both conductive yarn 404 and non-conductive yarn 403 according to one embodiment of the present invention. As illustrated, the figure shows that the conductive yarn 404 may be constructed from individual conductive fibers 406 grouped together and the non-conductive yarn 403 may be constructed from individual non-conductive fibers 405 grouped together.

By way of example only, the conductive yarn 404 and the non-conductive yarn 403 may be woven so as to form a grouping 402 of conductive yarn 404 and non-conductive yarn 403, as also depicted with FIG. 1. More specifically, the grouping 402 of the conductive yarn 404 and the non-conductive yarn 403 may be woven with other groupings of conductive yarn 404 and the non-conductive yarn 403. This may then result in the formation of a weaved pattern, as again, also depicted in FIG. 1. It should be noted that different number of conductive yarn 404 may be combined with non-conductive yarn 403 to from a grouping 402, which may impact the accuracy in monitoring the electrical resistivity or conductivity of the rope. For example, the greater number of conductive yarn may result in higher accuracy for monitoring the residual strength of the rope.

Additionally, the size of the conductive fibers 406 and the volume of its electrical conductivity may be additional factors for determining the bulk electrical resistance of the conducting yarn 404. The bulk electrical resistivity of the conducting yarn 404 may be directly proportional to determining the number of undamaged fibers in the rope bundle 401. Therefore, the monitoring of the bulk electrical resistivity or conductivity of the rope bundle 401 may help determine whether there is sufficient damage to the rope so that it should no longer be in use.

The resistance R of a single conductive fiber 406 of length l may be represented by the following formula:

$$R = \frac{l \times ρ}{A} = \frac{4 \times l \times ρ}{π \times {d}^{2}}$$

where ρ is the electrical resistivity of a conductor and A is the cross-sectional area of the conducting component of the conducting fiber 406, which has a nominal diameter, d.
Furthermore, the bulk resistance, R_{bulk} (l), of a yarn with n fibers can be determined by considering the yarn as a set of parallel resistors:

$$\frac{1}{{R}_{bulk} ( l )} = \frac{1}{{R}_{1} ( l )} + \frac{1}{{R}_{2} ( l )} + … \frac{1}{{R}_{n} ( l )}$$

When the conductive fiber geometry is symmetric and uniform, the R_{bulk} (l) becomes

$${R}_{n} ( l ) = \frac{ρ}{An} .$$

Additionally, where the rope is constructed with uniform fibers, the failure load, F(m), may be given by the following formula:

F(m)=qσ_{c}Am

where q is a correlation coefficient that depends on the volume fraction of conducting fibers to the nonconducting fibers in the rope. σ_{c} is the fracture stress of the conducting fiber, and A is the cross-sectional area of one fiber. In order to correlate the total number of broken unbroken fibers to the total number of unbroken conductive fibers, a probability factor, q, may be based on the volume fraction or the number fraction if the fibers have similar dimensions.

A rope bundle 401 with the lowest bulk resistance will be at the onset when the rope bundle 401 is first utilized, which will also correspond to its initial break strength, Tₒ. As the rope bundle 401 is in service, the rope bundle 401 will begin to loose strength and the resistance will begin to increase [R₁ (l), R₂ (l), Rₙ(l)]. When the resistance increases past the rope bundle's predefined break strength limit, T1, the rope bundle will be considered to be unsafe for future use.

The readings of the rope bundle's electrical resistance can be done at the electrical termination points of the conducting fiber 406. By way of example only, the conducting fiber 406 may be terminated at the ends of the rope bundle 401 when the conducting fibers 406 are separated from the non-conducting fibers 405. In some embodiments, the electrical termination points (not shown here) of the conducting fiber 406 may be constructed using any one of the many available polymer metallization methods known. Such exemplary methods may include electroplating, electroless plating, conducting ink coating, vapor deposition, mechanical crimps, screw terminals and the like. Once the electrical termination points are created from the ends of the conductive fiber 406, an electronic reader (not shown here) may be connected directly to the terminated ends so as to inspect the rope bundle 401 for damage by measuring the electrical resistivity of the conducting fibers 406.

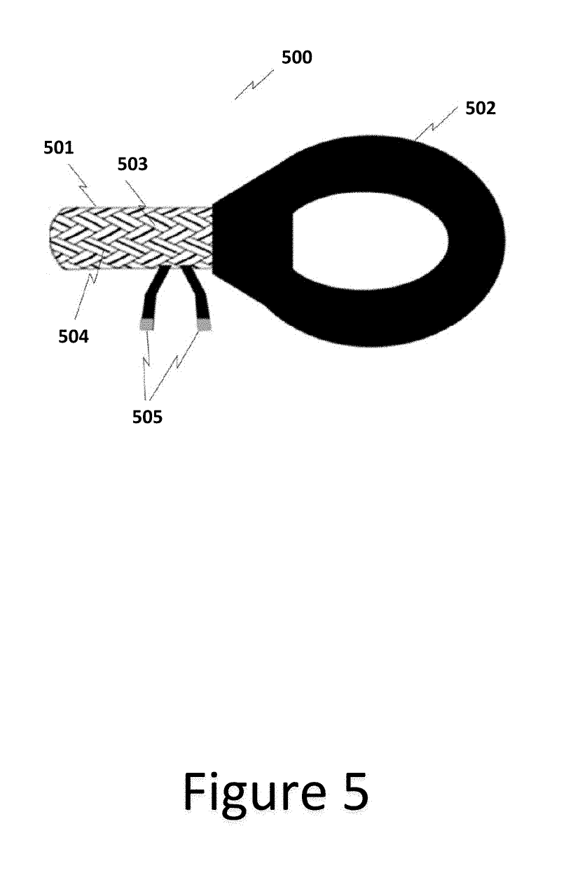

FIG. 5 illustrates a multi-layer rope 500 with a protective wrap 502 at one end according to one embodiment of the present invention. As depicted in the figure, the multi-layer rope 500 includes a conductive yarn 504 woven into a weave pattern with non-conductive yarn 503.

In some embodiments, the conductive yarn 504 may be bundled or grouped together at one end so that the conductive fibers are electrically terminated at one end. The electrical termination points 505 of the conductive fibers may be bare and exposed to the environment. This may then allow an electronic reader (not shown here) to make direct contact with the bare electronic termination points 505. In some embodiments, each of the electrical termination points 505 may be associated with conductive fibers that are located at different layers or specific sections of the multi-layer rope 500. This then allows a user to monitor the different sections of the multi-layer rope 500 for damage.

The multi-layer rope 500 may also have an eye-splice type configuration on one or both ends of the multi-layer rope 500. To further enhance the multi-layer rope 500 for rugged use, the eye splice section may be covered with a rubber component or hard protective cover. However, when ropes with eye spliced loops are used as slings, the neck portion just below the eye splice is often more susceptible to damage. To monitor this neck portion of the multi-layer rope 500, the conducting fibers 504 may be separated from the nonconducting fibers 503 and the conducting fibers 504 may be terminated just below the neck. By way of example only, one of the bare electronic termination points 505 may contain the conducting fibers associated with those that are present in the eye splice section of the multi-layer rope 500. This will then allow an electronic reader (not shown here) to obtain direct electrical resistance measurements for the conducting fibers 504 located in the eye splice section. Additionally, the other bare electronic termination point 505 may be associated with another section of the rope, such as the inner core layer of the other remaining length of the multi-layer rope 500. Additional bare electronic termination points 505 may be included at any end or section of the finite length of the multi-layer rope 500.

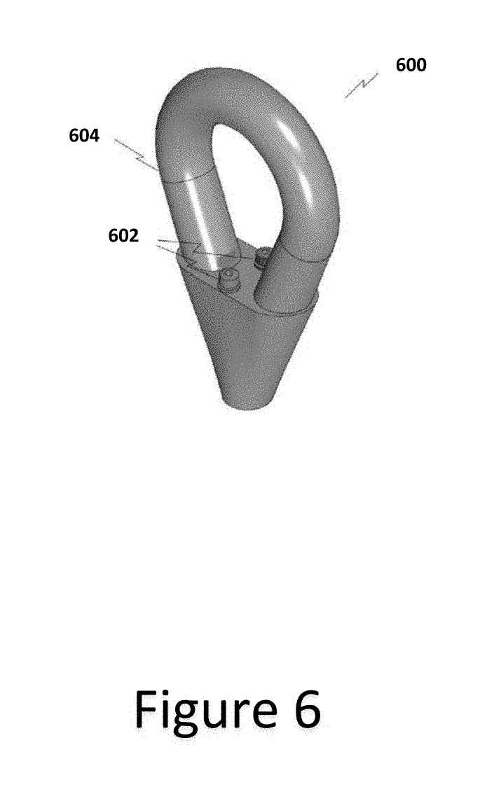

FIG. 6 illustrates a protective attachment end 600 with electrical connections 602 according to one embodiment of the present invention. Here, the protective attachment end 604 is placed at one or both ends of the rope. Additionally, the protective attachment end 600, by way of example, may include a hardened rubberized surface. However, it should be noted that the protective attachment end 604 may be composed of any surface material that has non-conductive properties. In some instances, the shape of the protective attachment end 600 may be configured to be a loop shape 604. However, it should be noted that the protective attachment end 604 may be configured to take any shape or form.

Additionally, the protective attachment end 600 may include electrical terminal ends 602. The electrical terminal ends 602 may be connected to bundles of conductive fiber grouped together, so that an electronic reader (not shown here) can directly connect to these terminal ends 602 to monitor changes in the rope's electrical properties.

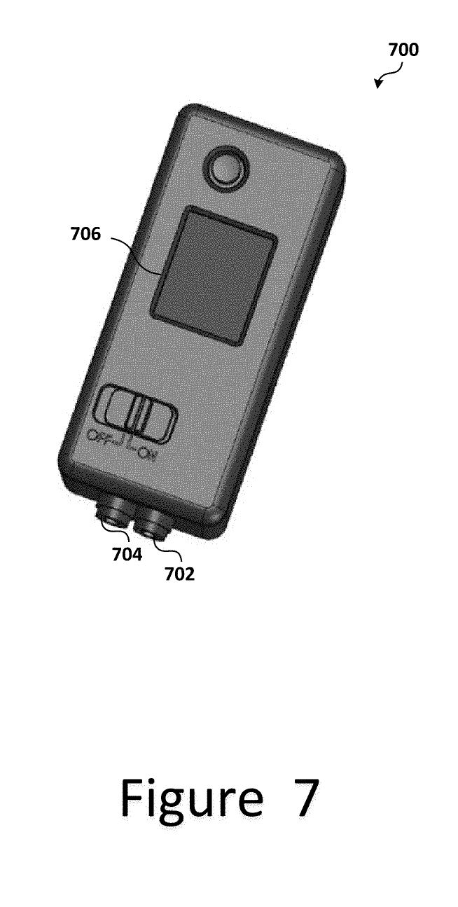

FIG. 7 illustrates an electronic device 700 to connect directly to the electrical terminations of a rope according to one embodiment of the present invention. The electronic device 700 may be configured to be a handheld reader that measures the electrical resistance of the rope, which will provide the rope's residual strength. The rope's residual strength data may be displayed on the screen 706 and the data may be stored onto the electronic device 700. The stored data may then be later transmitted onto a computing device via USB or Bluetooth technology.

Additionally, the electronic device 700 may contain a microcontroller board and an analog voltage reader for the resistance measurements. Additionally, the electronic device 700 may further contain a storage memory device with an expansion board that offers integrated LCD support, Universal Serial Bus/Universal Asynchronous Receiver/Transmitter connectivity, power conditioning circuitry, and other various features for future expansion, such as Ethernet port.

The electronic device 700 may also include electrical connection points 702, 704 that are configured to snap onto or make contact with the corresponding electrical termination points on the rope. The electronic device 700 may be further calibrated for high electrical resistance measurements.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

What is claimed is:

1. A system for monitoring synthetic ropes for damage comprising:
a synthetic rope comprising:
non-conductive fibers; and
conductive fibers comprising a conductive core and a non-conductive sheath surrounding the conductive core, wherein conductive fibers are grouped and terminated to form an electrical termination point;
an electronic reader configured to make contact with the electrical termination point to measure the electrical resistance of the synthetic rope.

2. The system of claim 1, wherein the synthetic rope comprises at least one inner layer and one outer layer.

3. The system of claim 2, further comprising two or more electrical connections points such that each electrical connection point corresponds to a particular section on the synthetic rope to be monitored.

4. The system of claim 3, wherein each electrical connection point corresponds to the conductive fibers of a particular layer of the synthetic rope.

5. The system of claim 1, wherein the synthetic rope comprises of an eye splice configuration at one end of the synthetic rope.

6. The system of claim 5, wherein at least one electrical termination point is located at a neck of the synthetic rope immediately below the eye splice configuration.

7. The system of claim 5, wherein the eye splice configuration is covered with a hard surface protective layer.

8. The system of claim 2, further comprising an attachment piece on at least one end of the synthetic rope.

9. The system of claim 8, wherein the attachment piece comprises an electrical termination point in contact with the conductive fibers.

10. The system of claim 9, wherein the attachment piece is constructed of hard non-conductive material.

11. A method of monitoring synthetic ropes for damage comprising:
obtaining a synthetic rope comprising:
non-conductive fibers; and
conductive fibers comprising a conductive core and a non-conductive sheath surrounding the conductive core, wherein conductive fibers are grouped and terminated to form an electrical termination point;
placing an electronic reader in contact with the electrical termination point to measure an electrical resistance of the synthetic rope.

12. The method of claim 11, further comprising two or more electrical termination points such that each electrical termination point corresponds to a particular section of the synthetic rope to be monitored.

13. The method of claim 11, further comprising determining the synthetic rope is no longer safe for use when the electronic reader measures the electrical resistance of the synthetic rope to be higher than a predetermined break strength limit.

14. The method of claim 11, wherein the synthetic rope comprises an eye splice configuration at one end of the synthetic rope.

15. The method of claim 14, wherein at least one electrical termination point is located at a neck of the synthetic rope immediately below the eye splice.

16. The method of claim 15, wherein the eye splice configuration is covered with a hard protective surface.

17. A synthetic rope comprising:
Non-conductive fibers; and
conductive fibers comprising a conductive core and a non-conductive sheath surrounding the conductive core;
wherein the non-conductive fibers and conductive fibers are woven together and the conductive fibers are grouped and terminated at least one end of the synthetic rope to form an electrical termination point.

18. The synthetic rope of claim 17, wherein the synthetic rope comprises an eye splice configuration at one end of the synthetic rope.

19. The synthetic rope of claim 18, wherein at least one electrical termination point is located at a neck of the synthetic rope immediately below the eye splice.

20. The synthetic rope of claim 17, wherein the electrical termination point is formed by electroplating, electroless plating, conducting ink coating, or vapor deposition of the conductive fibers.
